(19) United States
(12) Patent Application Publication
(10) Pub. No.: US 2025/0378016 A1
(43) Pub. Date: Dec. 11, 2025

(54) APPARATUS FOR MANAGING STORAGE SYSTEM

(71) Applicant: Hitachi Vantara, Ltd., Yokohama-shi (JP)

(72) Inventors: Shohei TAKASHIMA, Yokohama-shi (JP); Tomohiro KAWAGUCHI, Yokohama-shi (JP)

(21) Appl. No.: 19/074,534

(22) Filed: Mar. 10, 2025

(30) Foreign Application Priority Data
Jun. 5, 2024 (JP) 2024-091396

(51) Int. Cl. G06F 12/02

(52) U.S. Cl. CPC G06F 12/0223

(57) ABSTRACT

An apparatus stores storage resource management information for managing information on a throughput performance resource and a response time of a storage apparatus in each of a main site and a remote site. The apparatus receives a performance requirement including response performance and throughput performance for a volume copy pair including a primary volume in the main site and a secondary volume in the remote site. The apparatus determines whether there is a storage apparatus satisfying the performance requirement in both the main site and the remote site with reference to the storage resource management information. When there is a storage apparatus satisfying the performance requirement in both the main site and the remote site, the apparatus determines to create the volume copy pair.

### CLAIM OF PRIORITY

The present application claims priority from Japanese patent application JP 2024-091396 filed on Jun. 5, 2024, the content of which is hereby incorporated by reference into this application.

### BACKGROUND OF THE INVENTION

### 1. Field of the Invention

The invention relates to management of a storage system.

### 2. Description of Related Art

In recent the use of a cloud in an IT infrastructure is increasing, and even in an on-premise environment, a measure such as a cloud environment is developed. As an operation of such a cloud environment, an operation in which an infrastructure administrator designs an infrastructure according to an application requirement in the related art was changed to a self-service-type operation in which an application engineer selects and uses an infrastructure that meets a requirement from an infrastructure designed by determining a service level in advance by the infrastructure administrator. In such an operation, it is important whether a defined service level is actually satisfied, and the same applies to a copy pair configuration in disaster recovery.

There is a storage system that redundantly stores data between remote locations in order to protect important data from a failure in a data center unit due to a disaster or the like. For example, there is a function called storage remote copy in which data is copied between paired volumes, and consistency of data is maintained when a host computer issues data write request. Synchronous copy and asynchronous copy are known as such remote copy.

In disaster recovery, configurations of storage apparatuses that perform remote copy may be made uniform so as to prevent performance deterioration after failover. For example, PTL 1 discloses that a primary volume and a secondary volume are paired in the same storage layer.

### Citation List

### Patent Literature

PTL 1: JP2007-328468A

### SUMMARY OF THE INVENTION

For example, in a configuration in which remote copy is performed in a self-service-type infrastructure in which an application engineer can perform an infrastructure operation, the application engineer requests that predetermined performance requirements are satisfied after failover.

An apparatus for managing a storage system according to an aspect of the invention includes a processor, and a storage device, in which the storage device stores storage resource management information for managing information on a throughput performance resource and a response time of a storage apparatus in each of a main site and a remote site, and the processor is configured to receive a performance requirement including response performance and throughput performance for a volume copy pair including a primary volume in the main site and a secondary volume in the remote site, determine whether there is a storage apparatus satisfying the performance requirement in both the main site and the remote site with reference to the storage resource management information, and determine to create the volume copy pair when there is the storage apparatus satisfying the performance requirement in both the main site and the remote site.

In the copy pair, performance of a volume after failover can be maintained.

### BRIEF DESCRIPTION OF THE DRAWINGS

FIG. 1 schematically shows a logical configuration of a system according to an embodiment of the present specification.

FIG. 2 is a diagram showing a hardware structure example of a storage operation management server according to an embodiment of the present specification.

FIG. 3 shows a configuration example of a service catalog database.

FIG. 4 shows a configuration example of a volume information database.

FIG. 5 shows a configuration example of a storage resource management database.

FIG. 6 shows a configuration example of a site alert threshold management database.

FIG. 7 shows an example of information indicating that a service catalog interface unit prompts input of a user via a GUI of a terminal and receives the input from the user.

FIG. 8 shows a volume performance requirement generated from volume related information on a volume name “Prod1”.

FIG. 9A is a flowchart showing an example of creation processing of one volume or one remote copy pair executed by a volume creation unit.

FIG. 9B is a flowchart showing an example of the creation processing of one volume or one remote copy pair executed by the volume creation unit.

FIG. 10 shows a performance requirement of a volume Test2 that is calculated by the service catalog interface unit.

FIG. 11 shows update of the storage resource management database.

FIG. 12 shows a state in which information on a new volume Test2 is added to a volume information database in which information on an existing volume Test1 is registered.

FIG. 13 is a flowchart showing a processing example of a storage management support unit.

FIG. 14 shows an example of an alert image presented to a terminal of an IT administrator by the storage management support unit.

FIG. 15A is a flowchart showing a processing example of a volume creation unit in Embodiment 2.

FIG. 15B is a flowchart showing a processing example of a volume creation unit in Embodiment 2.

FIG. 16 is a flowchart showing a processing example of a storage management support unit in failover in Embodiment 2.

FIG. 17 is a flowchart showing a processing example of a storage management support unit in failover in Embodiment 3.

FIG. 18 is a flowchart showing rebalance determination when a minimum performance resource amount exceeds a threshold in Embodiment 3.

FIG. 19 is a flowchart showing rebalance determination when a maximum performance resource amount exceeds a performance resource amount of a storage apparatus in Embodiment 3.

FIG. 20 shows an example of an alert image presented to a terminal of an IT administrator by a storage management support unit in Embodiment 3.

### DESCRIPTION OF EMBODIMENTS

Hereinafter, for the sake of convenience, description will be made by being divided into a plurality of sections or embodiments as needed, but unless otherwise stated, those are not unrelated to one another, and one is a modification, details, supplementary description, and the like of a part or all of the other ones. Hereinafter, when referring to the number or the like of elements (including the number, a numerical value, an amount, a range, or the like), the number of elements is not limited to a specific number, and may be the specific number or more or the specific number or less, unless otherwise specified or except a case where the number is apparently limited to a specific number in principle.

A computer system can be implemented by one computer or a plurality of computers that can communicate with one another. A computer apparatus, a computer system, or a computing resource includes one or more interface apparatuses (for example, including a communication apparatus and an input and output apparatus), one or more storage devices (for example, including a memory (main storage) and an auxiliary storage device), and one or more processors.

When a function is implemented by executing a program by a processor, the function may be at least a part of the processor since specified processing is executed using a storage device and/or an interface apparatus as appropriate. The processing described with a function as a subject may be processing executed by a processor or a system including the processor.

The program may be installed from a program source. The program source may be, for example, a program distribution computer or a computer-readable storage medium (for example, a computer-readable non-transitory storage medium). Description of functions is an example. A plurality of functions may be integrated into one function, or one function may be divided into a plurality of functions.

In the following description, information from which an output is obtained in response to an input may be described by an expression such as an “xxx table”, but this information may be data having any structure. Therefore, the “xxx table” can be referred to as “xxx information”. In the following description, a configuration of each table is an example. One table may be divided into two or more tables, or all or some of two or more tables may be one table.

In an embodiment of the present specification, throughput performance that a storage apparatus can provide to a volume is referred to as a performance resource. A performance resource amount of the storage apparatus is an upper limit of throughput performance that the storage apparatus can provide. A performance resource allocated to each volume is referred to as a consumption performance resource. A total of the consumption performance resources in the storage apparatus is referred to as a consumption performance resource amount.

A throughput performance amount that the storage apparatus can provide to the volume is determined by processing performance of a processor provided in the storage apparatus, a memory bandwidth, throughput of a storage drive, and the like. These kinds of performance of the storage apparatus are measured in advance, and a performance resource amount of the storage apparatus is set in advance based on a measurement result.

### Embodiment 1

Hereinafter, an embodiment of the present specification will be described. In the embodiment, a configuration method for a remote copy pair that can guarantee performance in a copy destination after failover (FO) will be described. The remote copy pair is a pair of a main volume (primary volume) which is a copy source and a remote volume (secondary volume) which is a copy destination.

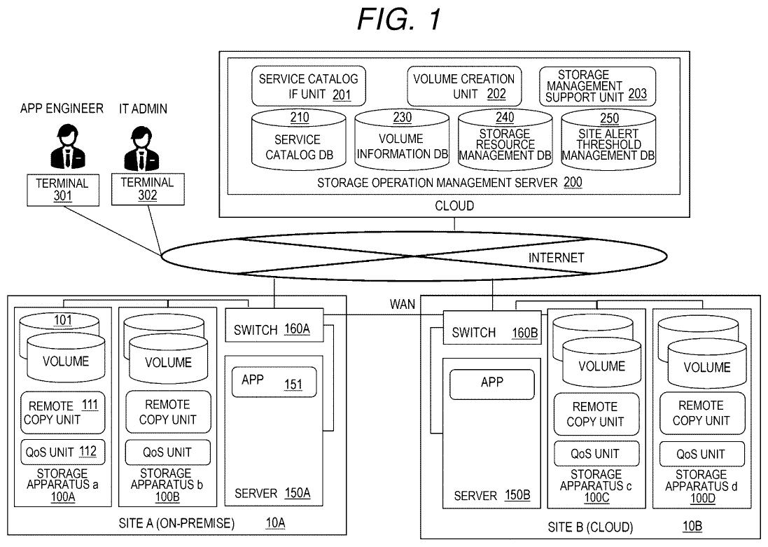

FIG. 1 schematically shows a logical configuration of a system according to an embodiment 41 of the present specification. The system includes a site A10A and a site B10B located at a remote location from the site A10A. Each of the sites 10A and 10B includes one or more storage apparatuses and one or more host servers that access the storage apparatuses. In a configuration example shown in FIG. 1, the site A10A is an on-premise site, and the site B10B is a cloud site. Alternatively, the site B100B may be an on-premise site. The site A10A and the site B10B can communicate with each other via a WAN.

In the configuration example shown in FIG. 1, in the site A10A, a storage apparatus a100A and a storage apparatus b100B are disposed, and a host server 150A is further disposed. In the configuration example shown in FIG. 1, in the site B10B, a storage apparatus c100C and a storage apparatus d100D are disposed, and a host server 150B is further disposed.

Each storage apparatus includes a volume 101 for storing data, a remote copy unit 111, and a quality of service (QoS) unit 112. In FIG. 1, components of the storage apparatus a100A are denoted by reference numerals as an example. The remote copy unit 111 executes and manages remote copy. For disaster recovery (DR), volumes formed in the site A10A and the site B10B constitute a remote copy pair. One site is a main site or a primary site, and the other site is a remote site or a secondary site. Data update of a primary volume is reflected to a secondary volume synchronously or asynchronously.

The quality of service (QoS) unit controls I/O processing in volume unit so that performance set for each volume is provided. Specifically, the QoS unit controls the I/O processing in volume unit so as to satisfy a performance upper limit and a performance lower limit (performance limit values) set for each volume.

The host servers 150A and 150B execute an application program 151 to access a storage apparatus in the same site. In FIG. 1, components of the host server 150A are denoted by reference numerals as an example.

A storage operation management server 200 is provided, for example, on a cloud and performs management of storage apparatuses in the site A100A and the site B100B. An application engineer and an IT administrator (also referred to as an infrastructure administrator) can access the storage operation management server 200 and systems in the site A10A and the site B10B by using respective terminals 301 and 302.

The storage operation management server 200 creates and manages volumes and a remote copy pair in response to access from the terminals 301 and 302. The storage operation management server 200 includes functional units of a service catalog interface unit 201, a volume creation unit 202, and a storage management support unit 203. The storage operation management server 200 further stores management information, and the management information includes a service catalog database 210, a volume information database 230, a storage resource management database 240, and a site alert threshold management database 250.

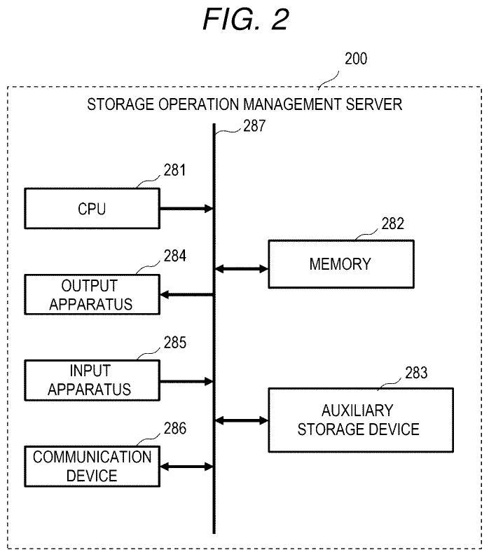

FIG. 2 is a diagram showing a hardware structure example of the storage operation management server 200 according to the embodiment of the present specification. Although a hardware structure example of the storage operation management server 200 will be described below, the user terminals 301 and 302 and the host servers 150A and 150B may have the same configuration.

Each of the storage apparatuses 100A to 100D may include one or more storage controllers and a plurality of storage drives. The storage drive may be shared by a plurality of storage apparatuses. The storage controller may include a front-end interface with a host and a back-end interface with a storage drive, in addition to a processor and a memory. A processor and/or a logic circuit of the storage controller can implement each functional unit of the storage apparatus.

The storage operation management server 200 includes a CPU (processor) 281 that executes various programs, a memory (main storage device) 282 that stores various programs, and an auxiliary storage device 283 that stores various kinds of data. The CPU 281 may include one or more cores, and the memory 282 is, for example, a DRAM including a volatile storage area. The auxiliary storage device 283 is, for example, a hard disk drive (HDD) or a flash memory, and can provide a nonvolatile storage area.

The storage operation management server 200 further includes an output device 284 for presenting information to a user of the apparatus, an input device 285 for inputting an instruction, an image, and the like by a user, and a communication device 286 for communicating with other devices. These devices are connected to one another by a bus 287.

The functional units of the storage operation management server 200 shown in FIG. 1 can be implemented by, for example, operating the CPU 281 according to a program. The CPU 281 reads and executes various programs from the memory 282 as necessary. The memory 282 can store programs corresponding to the functional units 201, 202, and 203 shown in FIG. 1. For example, each program is loaded from the auxiliary storage device 283 to the memory 282 and executed by the CPU 281. At least a part of the functional units may be implemented by a logic circuit.

The auxiliary storage device 283 stores data referred to or managed by various programs. For example, the auxiliary storage device 283 can store the databases 210, 230, 240, and 250 shown in FIG. 1.

The output device 284 includes devices such as a display, a printer, and a speaker. The input device 285 includes devices such as a keyboard, a mouse, and a microphone. The output device 284 presents an input result from a user and a processing result by the storage operation management server 200. An instruction from a user is input to the storage operation management server 200 using the input device 285. When the user terminal 3 is used, an input and output device functions in the same manner, and the output device 284 and the input device 285 can be omitted.

The communication device 286 is connected to, for example, a system including the user terminals 301 and 302 and the storage apparatuses in the sites 10A and 10B via a network (for example, the Internet), receives data transmitted from other apparatuses, and transmits a processing result by the storage operation management server 200 to other devices. Note that some devices may be omitted.

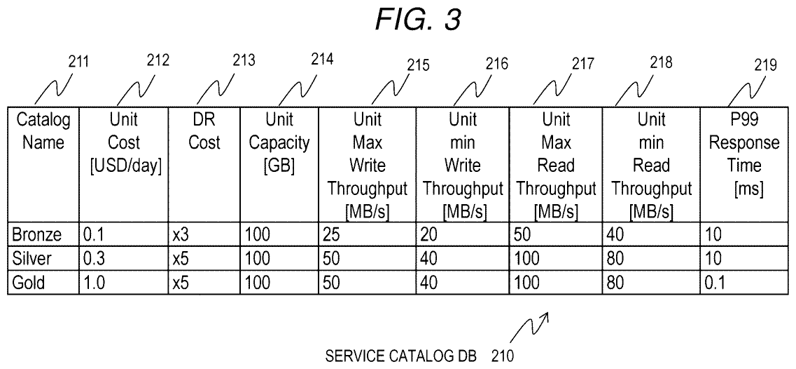

Hereinafter, various kinds of information stored in the storage operation management server 200 will be described. FIG. 3 shows a configuration example of the service catalog database 210. The service catalog database 210 manages a service level (service catalog) provided by a system to a volume. The service level indicates information on guarantee performance and cost for a volume. The service catalog database 210 may be prepared in advance by a service provider.

In the configuration example shown in FIG. 3, the service catalog database 210 includes a Catalog Name column 211, a Unit Cost column 212, a DR Cost column 213, a Unit Capacity column 214, a Unit Max Write Throughput column 215, a Unit min Write Throughput column 216, a Unit Max Read Throughput column 217, a Unit min Read Throughput column 218, and a P99 Response Time column 219.

The Catalog Name column 211 indicates a name for identifying a service level (service catalog). The Unit Cost column 212 indicates a cost per unit of each service level. One or a plurality of units can be allocated to each volume or each volume pair of remote copy. The DR Cost column 213 indicates a cost when a remote copy pair for disaster recovery is implemented.

The Unit Capacity column 214 indicates a capacity allocated to a volume per unit. The Unit Max Write Throughput column n 215 indicates a maximum value of write throughput per unit. When a plurality of units are allocated, a product of a value indicated by the Unit Max Write Throughput column 215 and the number of units is a maximum value of write throughput of a volume.

The Unit min Write Throughput column 216 indicates a minimum value of write throughput per unit. When a plurality of units are allocated, a product of a value indicated by the Unit min Write Throughput column 216 and the number of units is a minimum value of write throughput of a volume. The write throughput of a volume is controlled to fall within a range between the maximum value and the minimum value.

The Unit Max Read Throughput column 217 indicates a maximum value of read throughput per unit. When a plurality of units are allocated, a product of a value indicated by the Unit Max Read Throughput column 217 and the number of units is a maximum value of read throughput of a volume.

The Unit min Read Throughput column 218 indicates a minimum value of read throughput per unit. When a plurality of units are allocated, a product of a value indicated by the Unit min Read Throughput column 218 and the number of units is a minimum value of read throughput of a volume. The read throughput of a volume is controlled to fall within a range between the maximum value and the minimum value.

The P99 Response Time column 219 indicates an upper limit value of a 99% response time of an IO defined in advance for a volume. The defined IO may be, for example, a read request of a predetermined data amount. For example, it is guaranteed that the 99% response time of a read request of 4 KB is equal to or less than a value indicated by the column 219.

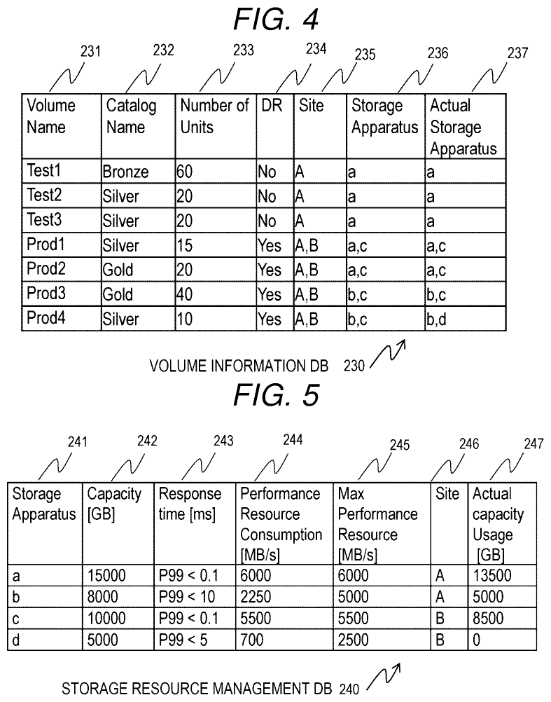

FIG. 4 shows a configuration example of the volume information database 230. The volume information database 230 manages information on a volume in a main site. The volume information database 230 is updated and managed by the storage operation management server 200.

In the configuration example shown in FIG. 4, the volume information database 230 includes a Volume Name column 231, a Catalog Name column 232, a Number of Units column 233, a DR column 234, a Site column 235, a Storage Apparatus column 236, and an Actual Storage Apparatus column 237.

The Volume Name column 231 indicates a name for identifying a volume. The Catalog Name column 232 indicates a service catalog name (service level name) given to a volume. The Number of Units column 233 indicates the number of service units allocated to a volume.

The DR column 234 indicates whether a disaster recovery function is used. That is, the DR column 234 indicates whether there is a secondary volume (remote volume) in a secondary site (remote site) constituting a remote copy pair with a main volume. The Site column 235 indicates a site where there is a single volume or a volume of a remote copy pair. The Storage Apparatus column 236 indicates a management storage apparatus that stores the single volume or the volume of the remote copy pair. The Actual Storage Apparatus column 237 indicates an actual storage apparatus that stores the single volume or the volume of the remote copy pair.

FIG. 5 shows a configuration example of the storage resource management database 240. The storage resource management database 240 manages a performance resource of each storage apparatus in the system. As described above, a performance resource amount of a storage apparatus is represented by throughput (MB/s) in the example.

In the configuration example shown in FIG. 5, the storage resource management database 240 includes a Storage Apparatus column 241, a Capacity column 242, a Response time column 243, a Performance Resource Consumption column 244, a Max Performance Resource column 245, a Site column 246, and an Actual Capacity Usage column 247.

The Storage Apparatus column 241 indicates an identifier for identifying a storage apparatus. The Capacity column 242 indicates a capacity of a storage area of a storage apparatus. The Response time column 243 indicates a response time of a storage apparatus. Here, the Response time 243 indicates an upper limit value of the 99% response time of an IO defined in advance. The defined IO may be, for example, a read request of a predetermined data amount.

The Performance Resource Consumption column 244 indicates a consumed amount of a total performance resource amount (throughput performance amount) of a storage apparatus. The Max Performance Resource column 245 indicates a total performance resource amount of a storage apparatus. The Site column 246 indicates a site where a storage apparatus is disposed. The Actual capacity Usage column 247 indicates an amount of a storage area used in a storage apparatus.

In the storage resource management database 240, the Performance Resource Consumption column 244 and the Actual capacity Usage column 247 are updated by the storage operation management server 200. Information in the other columns is set in advance by, for example, a service provider.

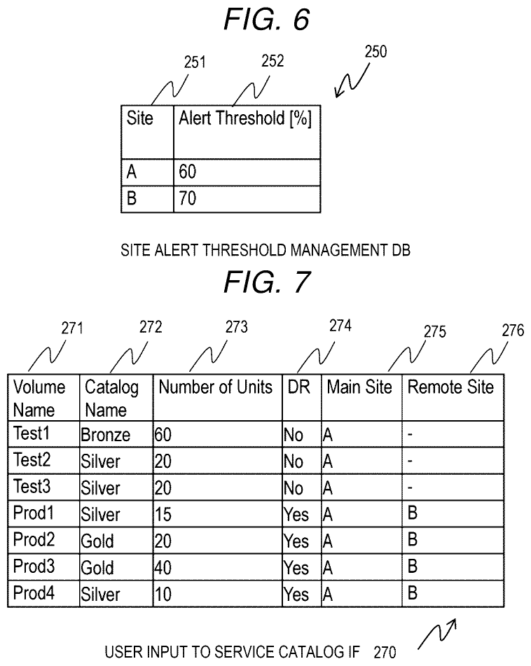

FIG. 6 shows a configuration example of the site alert threshold management database 250. The site alert threshold management database 250 manages a threshold that is referred to for determining whether to output an alert for each site. In the configuration example shown in FIG. 6, the site alert threshold management database 250 includes a Site column 251 and an Alert Threshold column 252. The Site column 251 indicates an identifier of a site, and the Alert Threshold column 252 indicates an alert threshold for each site. Details of a method for using the alert threshold will be described later.

Next, information input by an application engineer who is a service user to create a volume only in a main site or to create a remote copy volume pair in a main site and a remote site will be described. FIG. 7 shows an example of information indicating that the service catalog interface unit 201 prompts an input of a user via a GUI of the terminal 301 and receives the input from the user.

In the configuration example shown in FIG. 7, a user input 270 has a table configuration in which information on a plurality of volumes can be input at the same time, and the user input 270 includes a Volume Name column 271, a Catalog Name column 272, a Number of Units column 273, a DR column 274, a Main Site column 275, and a Remote Site column 276.

The Volume Name column 271 is a column for inputting a volume name. The Catalog Name column 272 is a column for inputting a service catalog (service level) name for a volume. The Number of Units column 273 is a column for inputting the number of units of a designated service catalog.

The DR column 274 is a column for inputting information on necessity of disaster recovery. That is, the DR column 274 is a column for inputting the presence or absence of a remote volume for constituting a copy pair. The Main Site column 275 and the Remote Site column 276 are columns for inputting a main site and a remote site, respectively. Only a main site is input to a volume that does not constitute a copy pair.

The input information is stored in the volume information database 230 after a corresponding volume is created. Specifically, the information is stored in the Volume Name column 231, the Catalog Name column 232, the Number of Units column 233, the DR column 234, and the Site column 235.

Hereinafter, processing of creating a volume according to a volume creation request from a user will be described. The service catalog interface unit 201 determines a performance requirement of a volume based on volume related information input by a user which is described with reference to FIG. 7. The volume creation unit 202 creates a volume so as to satisfy the performance requirement.

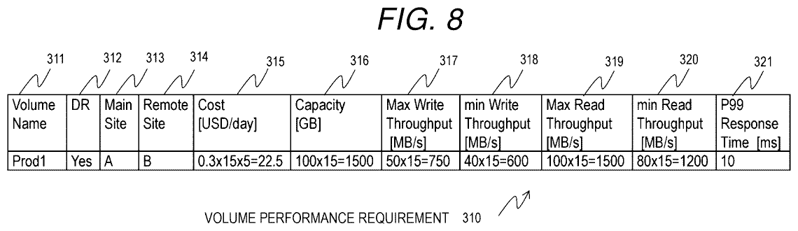

First, a method for calculating a volume performance requirement based on the volume related information input by a user will be described. FIG. 8 shows a volume performance requirement 310 generated based on volume related information on a volume name “Prod1”. The volume performance requirement 310 includes a Volume Name column 311, a DR column 312, a Main Site column 313, a Remote Site column 314, a Cost column 315, a Capacity column 316, a Max Write Throughput column 317, a min Write Throughput column 318, a Max Read Throughput column 319, a min Read Throughput column 320, and a P99 Response Time column 321.

User input information is a record of “Prod1” in the user input 270 shown in FIG. 7. The service catalog interface unit 201 stores values of the Volume Name column 271, the DR column 274, the Main Site column 275, and the Remote Site column 276 in the Volume Name column 311, the DR column 312, the Main Site column 313, and the Remote Site column 314 in the volume performance requirement 310, respectively.

Further, the service catalog interface unit 201 searches “Silver” in the Catalog Name column 211 in the service catalog database 210 shown in FIG. 2 based on “Silver” input in the Catalog Name column 272 of an entry of “Prod1”, and reads the entry.

A method for calculating volume performance will be described. As shown in FIG. 3, in an entry of a service catalog “Silver”, a value of the Unit Capacity column 214 is 100, a value of the Unit Max Write Throughput column 215 is 50, a value of the Unit min Write Throughput column 216 is 40, a value of the Unit Max Read Throughput column 217 is 100, and a value of the Unit min Read Throughput column 218 is 80.

The service catalog interface unit 201 acquires a value of the Number of Units column 273 from the entry of “Prod1” in the user input 270. In the example, the number of units is 15. The service catalog interface unit 201 calculates a product of the number of units of 15 and each of the values of the service catalog “Silver”, calculates values in the columns 316 to 320, which indicate volume performance, in the volume performance requirement 310, and stores the values. The P99 Response Time column 321 stores a value of the P99 Response Time column 219 in the service catalog database 210.

Next, a method for calculating a service cost will be described. In the entry of the service catalog “Silver”, a value of the Unit Cost column 212 is 0.3, and a value of the DR cost column 213 is five times. The DR column 274 of “Prod1” in the user input 270 indicates “Yes”. Therefore, a value of the Cost column 315 in the volume performance requirement 310 is calculated by a product of the value of the Unit Cost column 212, the value of the DR cost column 213, and the number of units of 15.

The volume creation unit 202 creates a volume satisfying the volume performance requirement 310 in the system, and notifies a user of an error when the volume satisfying the volume performance requirement 310 cannot be created.

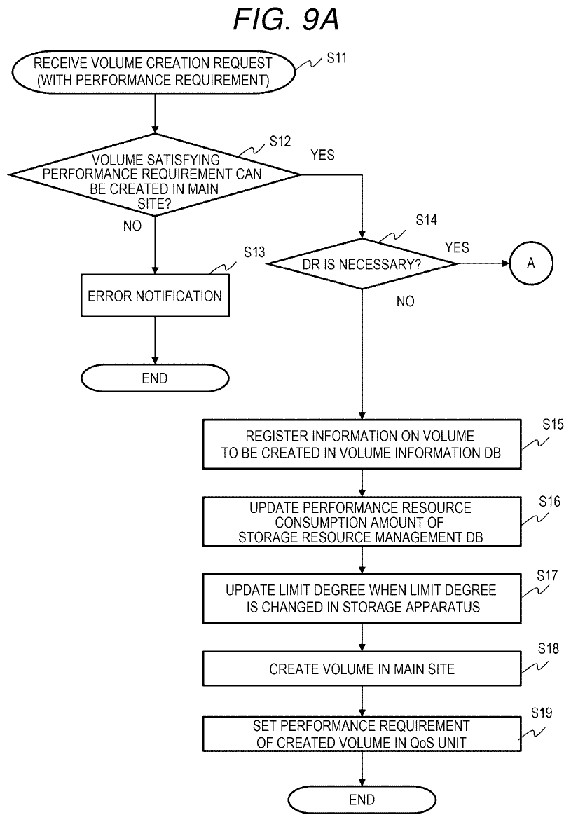

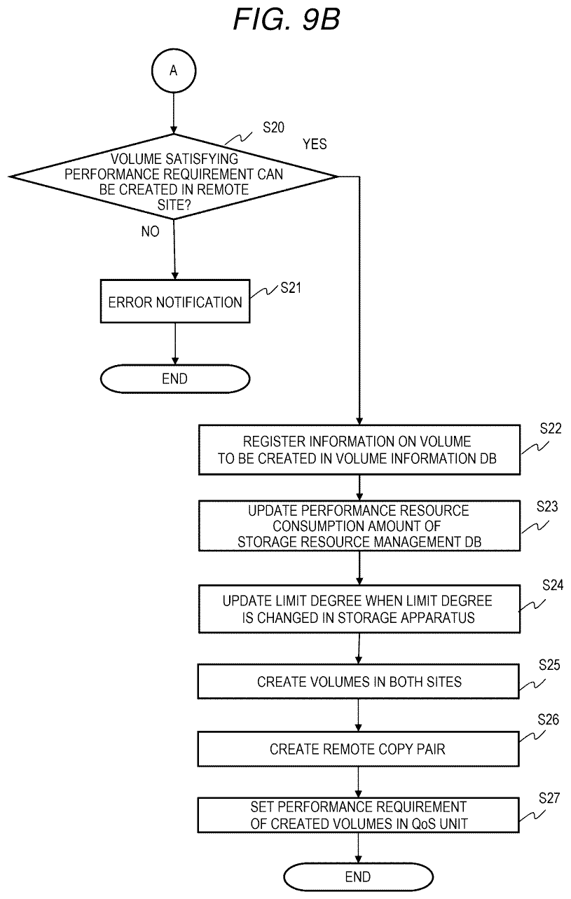

Hereinafter, details of processing of the volume creation unit 202 will be described. FIGS. 9A and 9B are flowcharts showing an example of creation processing of one volume or one remote copy pair executed by the volume creation unit 202.

First, the volume creation unit 202 receives a volume creation request from the service catalog interface unit 201 (S11). The volume creation request is accompanied by the volume performance requirement as described with reference to FIG. 8.

The volume creation unit 202 determines whether a volume satisfying performance requirement in a main site can be created. That is, the volume creation unit 202 determines whether there is a storage apparatus having a remaining performance resource that satisfies the volume performance requirement in the storage apparatus of the main site (S12).

When the volume satisfying the performance requirement designated in the main site cannot be created (S12: NO), the volume creation unit 202 notifies the terminal 301 of an error (S13). As a result, this flow ends.

When the volume satisfying the performance requirement designated in the main site can be created (S12: YES), the volume creation unit 202 refers to the DR column 312 in the volume performance requirement 310 and determines whether DR is necessary (S14).

When the DR is unnecessary (S14: NO), the volume creation unit 202 registers information on a volume to be created in the volume information DB 230 (S15). Further, the volume creation unit 202 updates a performance resource consumption amount in the Performance Resource Consumption column 244 in the storage resource management DB 240 (S16).

When a limit degree p of a performance resource allocation amount set for an existing volume in the storage apparatus is changed, the volume creation unit 202 updates the value (S17). The limit degree of the performance resource allocation amount will be described later. Next, the volume creation unit 202 creates a volume in the main site (S18), and further sets a performance requirement (QoS) of the created volume in the QoS unit 112 (S19). The QoS unit 112 executes IO control or the like according to an upper limit and a lower limit of throughput set for each volume, and controls allocation of a performance resource from a storage apparatus to a volume.

When it is determined in step S14 that DR is necessary (S14: YES), the flow proceeds to step S20 in FIG. 9B via a connector A. The volume creation unit 202 determines whether a volume satisfying performance requirement in the remote site can be created (S20). When the volume satisfying the performance requirement designated in the remote site cannot be created (S20: NO), the volume creation unit 202 notifies the terminal 301 of an error (S21). As a result, this flow ends.

When the volume satisfying the performance requirement designated in the remote site can be created (S20: YES), the volume creation unit 202 registers information on two volumes to be created in the volume information DB 230 (S22). Further, the volume creation unit 202 updates a performance resource consumption amount of storage apparatuses in the respective main site and remote site in the Performance Resource Consumption column 244 in the storage resource management DB 240 (S23).

When a limit degree ρ of a performance resource allocation amount set for an existing volume in the storage apparatus in each of the main site and the remote side is changed, the volume creation unit 202 updates the value (S24). Next, the volume creation unit 202 creates a volume in each of the main site and the remote site (S18), and further sets a performance requirement (QoS) of the created volume in the QoS unit 112 of the storage apparatus in each of the two sites (S19). The QoS unit 112 executes IO control or the like according to an upper limit and a lower limit of throughput set for each volume, and controls allocation of a performance resource from a storage apparatus to a volume.

Hereinafter, details of the processing S12 and S20 in which the volume creation unit 202 determines whether a volume can be created in the main site or the remote site will be described.

First, the following variables are defined.

Pij: maximum resource amount consumed when a volume i belongs to a storage apparatus j

Ri: product of Max read throughput in a selected catalog and the number of units

ri: product of Min read throughput in a selected catalog and the number of units

Wi: product of Max write throughput in a selected catalog and the number of units

wi: product of Min write throughput in a selected catalog and the number of units

αj: coefficient for determining a performance resource consumption amount of read throughput in the storage apparatus j

βj: coefficient for determining a performance resource consumption amount of write throughput in the storage apparatus j

Uj: performance resource amount consumed by the storage apparatus j

Tj: performance resource amount of the storage apparatus j

δij: whether the volume i belongs to the storage apparatus j (true: 1, false: 0)

σij: whether the storage apparatus j satisfies a response requirement of the volume i (true: 1, false: 0)

ρij: coefficient for determining how much performance of the volume i in the storage apparatus j is reduced (limit degree)

The volume creation unit 202 can use the following calculation formulas to manage performance resources.

$$Pij = max ( α jRi , β jWi )$$

$$pij = max ( α jri , β jwi )$$

$$Uj = {\sum }_{i = 1} {\cdot }^{n} δ ij \times pij \times Pij$$

The volume creation unit 202 searches for p satisfying the following formulas, and determines that a volume can be created when ρ can be found.

$$pi + 1 , j + Pi + 1 , j < max ( σ ij ( Ti - Uj ) )$$

$$Pij \geq pij \times Pij \geq pij$$

$$0 \leq pij \leq 1$$

When ρP satisfying a performance condition is found, the volume creation unit 202 updates p of each volume of the storage apparatus j in which the volume is created, and creates a new volume (at this time, Uj=Tj).

A combination of ρ can be obtained by combination optimization processing. The volume creation unit 202 may search for the combination of ρ by using, for example, artificial intelligence (machine learning model). Some methods for searching for the combination of ρ are known. For example, it is possible to uniformly increase an influence range as much as possible in the storage apparatus, to greatly reduce a part of the influence range as much as possible in the storage apparatus, or to give priority to each policy grade in the storage apparatus.

According to the above method, the volume creation unit 202 can select a storage apparatus that can satisfy the volume performance requirement, which is a storage apparatus having a largest remaining capacity resource consumption amount.

As described above, a maximum throughput requirement and a minimum throughput requirement are allocated to a volume, and the volume creation unit 202 creates the volume when a performance resource amount that can be provided by a storage apparatus and a required performance resource amount are satisfied. The required performance resource amount is larger in the maximum throughput requirement than in the minimum throughput requirement. Therefore, even if the maximum throughput requirement is not satisfied, when the minimum throughput requirement is satisfied, the volume unit 202 creates a new volume while reducing performance of each volume in the storage apparatus. When the minimum throughput requirement of the new volume is not satisfied, the volume creation unit 202 notifies an error without creating the new volume.

Hereinafter, details of processing f the volume creation unit 202 will be described. Here, it is assumed that only a volume Test1 was created and a creation request for a volume Test2 was received.

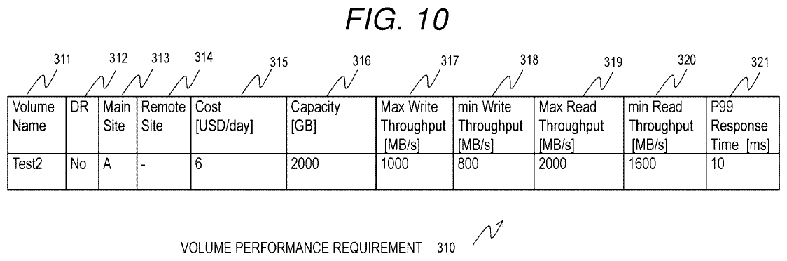

FIG. 10 shows a performance requirement 310 for the volume Test2 that is calculated by the service catalog interface unit 201. The volume creation unit 202 searches for a storage apparatus that can satisfy a response time requirement “10” in the site A10A that is the main site. The volume creation unit 202 knows that the storage apparatus a100A and the storage apparatus b100B satisfy the requirement.

The volume creation unit 202 calculates a remaining performance resource based on respective performance resource amounts and consumption performance resource amounts in the storage apparatus a100A and the storage apparatus b100B. Since the Test1 is created in the storage apparatus a100A and the consumption performance resource amount of the Test1 is 1800, it is calculated that 6000−1800=4200 performance resources remain in the storage apparatus a100A and 5000 performance resources remain in the storage apparatus b100B.

The volume creation unit 202 calculates performance resources required for satisfying throughput performance of the volume Test2 by using coefficients α and β unique to the storage apparatus a100A and the storage apparatus b100B, respectively. α and β are set in advance based on a result of preliminary measurement or the like. Here, it is assumed that α=0.6 and β=0.5 for the storage apparatus a100A, and α=0.5 and β=0.4 for the storage apparatus b100B.

Based on the maximum read throughput requirement “2000” and the maximum write throughput requirement “1000” of the volume Test2, it is calculated that αR=1200>βW=500 in the storage apparatus a100A and αR=1000>βW=400 in the storage apparatus b100B. Therefore, a performance resource amount required to create the volume Test2 in the storage apparatus a100A is 1200, and a performance resource amount required to create the volume Test2 in the storage apparatus b100B is 1000.

The volume creation unit 202 determines to arrange the volume Test2 in the storage apparatus b100B in which a remaining amount of the performance resource amount is larger and a performance resource required for creating the volume Test2 can be ensured. Since DR is not required in this case, the volume creation unit 202 determines that the volume Test2 can be arranged in the main site 10A, actually creates a volume, and sets a performance requirement in the QoS unit 112.

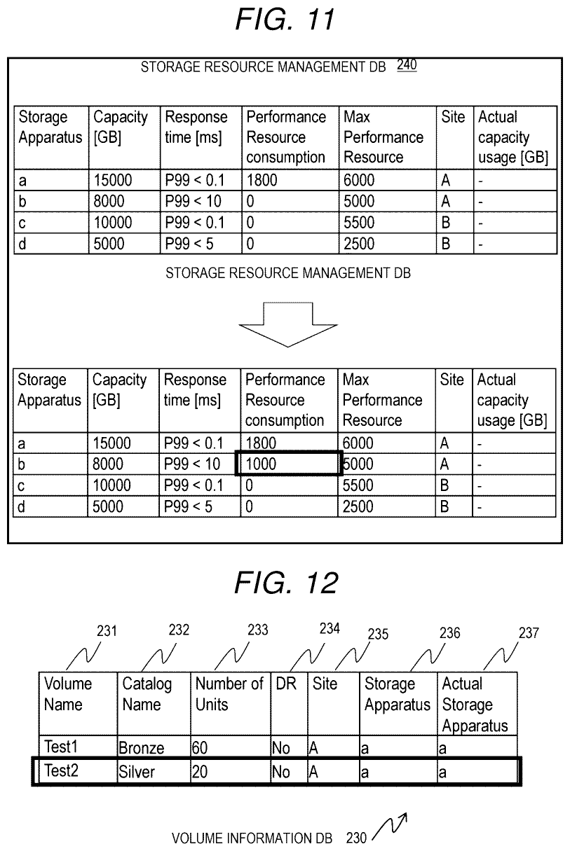

After creating the volume, the volume creation unit 202 adds information to the storage resource management database 240. FIG. 11 shows update of the storage resource management database 240. Specifically, a value of the Performance Resource consumption column of the storage apparatus b100B is updated.

Further, the volume creation unit 202 adds information on the created volume Test2 to the volume information database 230. FIG. 12 shows a state in which information on the new volume Test2 is added to the volume information database 230 in which information on the existing volume Test1 is registered.

Next, processing of the storage management support unit 203 will be described. The storage management support unit 203 issues, to the terminal 302 of the IT administrator, an alert indicating expansion or rebalance of a volume (volume rearrangement), which is mandatory or recommended for storage facility. Accordingly, the IT administrator can know performance resource shortage of a storage system. For example, the storage management support unit 203 can execute processing according to a request from the IT administrator or execute processing periodically.

When performance of any one storage apparatus is shortage, the storage management support unit 203 outputs, to the terminal 302 of the IT administrator, an alert indicating the necessity of expansion or rebalance (volume relocation) of a storage apparatus. Specifically, the storage management support unit 203 determines the necessity of the alert based on a performance requirement of a volume under the assumption that the performance limit degree ρ is not used and a performance resource amount of a storage apparatus.

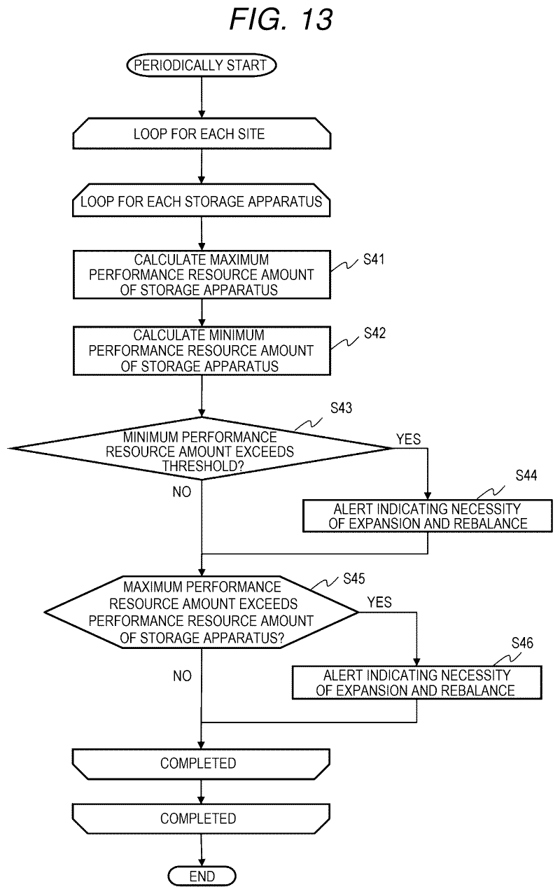

FIG. 13 is a flowchart showing a processing example of the storage management support unit 203. Steps S11 to S16 are executed for each storage apparatus in each site. First, the storage management support unit 203 calculates a maximum performance resource amount of a storage apparatus (S41). Further, the storage management support unit 203 calculates a minimum performance resource amount of the storage apparatus (S42).

Next, the storage management support unit 203 determines whether the minimum performance resource amount exceeds a predetermined threshold (S43). When the minimum performance resource amount exceeds the predetermined threshold (S43: YES), the storage management support unit 203 outputs an alert indicating the necessity of expansion and rebalance to the terminal 302 (S44).

When the minimum performance resource amount does not exceed the predetermined threshold (S43: NO) or after step S44, the storage management support unit 203 determines whether the maximum performance resource amount exceeds a performance resource amount of the storage apparatus (S45). When the maximum performance resource amount exceeds the performance resource amount of the storage apparatus (S45: YES), the storage management support unit 203 outputs an alert indicating the necessity of expansion and rebalance to the terminal 302 (S46). When the maximum performance resource amount does not exceed the performance resource amount of the storage apparatus (S45: NO) or after step S46, this flow ends.

Hereinafter, a specific example of the storage management support unit 203 described with reference to FIG. 13 will be described. First, calculation S41 of the maximum performance resource amount of the storage apparatus will be described. Here, it is assumed that seven volumes are created as shown in the volume information database 230 in FIG. 4.

An example of calculating the maximum performance resource amount for the storage apparatus a100A in the site A10A will be described. The storage management support unit 203 searches the Actual Storage Apparatus column 236 in the volume information database 230 for a volume arranged in the storage apparatus a100A, and knows that “Test1”, “Test2”, “Test3”, “Prod1”, and “Prod2” are arranged.

Next, the storage management support unit 203 acquires values of the Catalog Name column 232 and the Number of Units column 233 of each volume from the volume information database 230. The storage management support unit 203 acquires values of the Unit Max Write Throughput column 215 and the Unit Max Read Throughput column 217 from corresponding Catalog Name rows of the service catalog database 210.

At this time, the storage management support unit 203 compares α “0.6” and β “0.5” of the storage apparatus a100A with the value of Unit Max Write Throughput and the value of Unit Max Read Throughput, respectively. The storage management support unit 203 calculates the maximum performance resource amount by using a value of Read throughput which has a larger value. The maximum performance resource amount is calculated by α×(Unit Max Read Throughput)×(Number of Units).

Here, “Test1” is 0.6×50×60=1800. “Test2” is 0.6×100×20=1200. “Test3” is 0.6×100×20=1200. “Prod1” is 0.6×100×15=900. “Prod2” is 0.6×100×20=1200. Therefore, a maximum performance resource amount Umax is 6300.

Next, the calculation S42 of the minimum performance resource amount of the storage apparatus will be described. The minimum performance resource amount can be calculated by using the values of the Unit min Write Throughput column 216 and the Unit min Read Throughput column 218 of the service catalog database 210 in the above calculation. A minimum performance resource amount Umin is 5040.

Next, the comparison S43 between the minimum performance resource amount and the threshold will be described. The storage management support unit 203 multiplies a value “6000” of the Max Performance Resource column 245 in a row of the storage apparatus a100A in the storage resource management database 240 by a threshold “60%” of the site A in the site alert threshold management database 250. Then, the integrated value (threshold) is compared with the minimum performance resource amount Umin obtained by the above calculation. In the storage apparatus a100A, since the minimum performance resource amount Umin 5040>the threshold 3600, the necessity of expansion or rebalance is notified. Here, a difference of 1440 is presented as a mandatory expansion amount.

Next, the comparison S45 between the maximum performance resource amount and the performance resource amount of the storage apparatus will be described. The storage management support unit 203 compares the maximum performance resource amount Umax obtained by the calculation as described above with a value of the Max Performance Resource column 245 in a row of the storage apparatus a in the storage resource management database 240.

As described above, the maximum performance resource amount Umax is 6300, and the value of the Max Performance Resource column 245 of the storage apparatus a100A is 6000. Since 6300>6000, the necessity of expansion or rebalance is notified. A difference is 300, which is a recommended expansion amount. Here, since the mandatory expansion amount is 1440 and the mandatory expansion amount is larger than the difference, 1440 is presented as the recommended expansion amount.

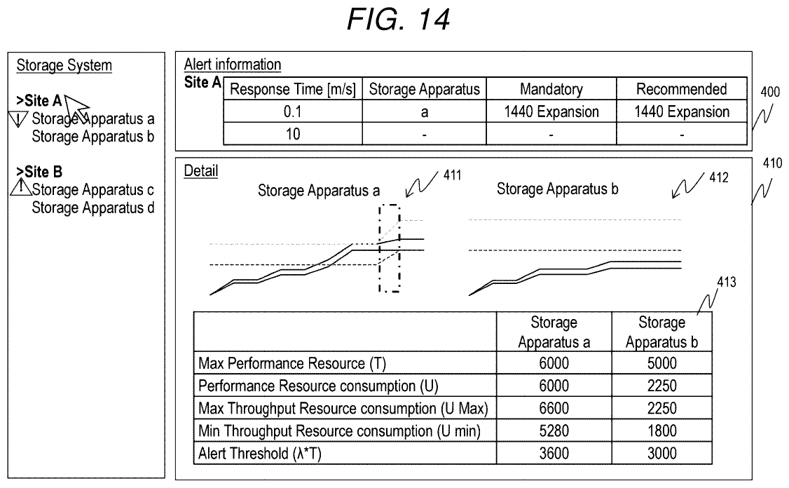

FIG. 14 shows an example of an alert image presented to the terminal 302 of the IT administrator by the storage management support unit 203. The image indicates information on a selected site, and here, the site A is selected. A section 400 indicates the mandatory expansion amount and the recommended expansion amount of a performance resource amount in the site A. As described above, 1440 is presented as the mandatory expansion amount and the recommended expansion amount of the storage apparatus a100A satisfying a requirement of the response time 0.1.

A section 410 indicates information on a performance resource amount of a storage apparatus in the site A. Specifically, graphs 411 and 412 indicate information on the storage apparatus a100A and the storage apparatus b100B, respectively. The graphs 411 and 412 show a maximum required performance resource amount, a minimum required performance resource amount, an available performance resource amount, and a past value and a calculated value of a time change of a threshold. A rectangle in the graph 411 indicates a period from the start of the expansion to the completion of the expansion in the storage apparatus a100A. Further, a table 413 shows information on performance resources of the storage apparatus a100A and the storage apparatus b100B in the site A100A.

An example of a calculation formula that can be used in the above processing by the storage management support unit 203 will be described.

The storage management support unit 203 can calculate a maximum performance resource amount U from a volume in a storage apparatus j according to the following formula.

$$Uj , max = {\sum }_{i = 1} {\cdot }^{n} δ ij \times Pij$$

The storage management support unit 203 can calculate a minimum performance resource amount from a volume in the storage apparatus j according to the following formula.

$$Uj , min = {\sum }_{i = 1} {\cdot }^{n} δ ij \times pij$$

The storage management support unit 203 can calculate a performance resource amount mandatory for the expansion such that a minimum performance resource amount does not exceed a threshold according to the following formula. A correction may be performed in volume unit.

$${\sum }_{j = 1} {\cdot }^{m} max ( Uj , min - γ jkTj , 0 )$$

γjk is a threshold set for a site k where the storage apparatus j is arranged.

The storage management support unit 203 can calculate a performance resource amount of a storage apparatus in which the performance resource amount is shortage as compared with a maximum performance resource consumption amount according to the following formula. A correction may be performed in volume unit.

$${\sum }_{j = 1} {\cdot }^{m} max ( Uj , max - Tj , 0 )$$

As described above, in the present embodiment, when an application engineer uses the remote copy function, it is possible to ensure that performance deterioration does not occur after failover because a volume and a pair satisfying a performance requirement are created. In addition, even when a DR environment is provided, since it is not necessary to uniform a storage configuration, the IT administrator can select a more suitable environment as an on-premise environment or a cloud environment.

### Embodiment 2

Hereinafter, an embodiment of the present specification will be described. In the embodiment, before failover, a remote volume is arranged in a storage apparatus different from a management storage apparatus, and upon failover, the remote volume is rearranged in the management storage apparatus. Accordingly, a storage apparatus of a remote destination can be used more efficiently.

A system configuration in the embodiment is shown in FIG. 1, and it is assumed that the site B10B is a remote site and is present in a cloud. It is assumed that a storage apparatus in the cloud site B10B is not started in an initial stage. The volume creation unit 202 determines whether QoS corresponding to a performance requirement of a volume can be set in the remote destination, and a timing of actually allocating the QoS may be at the time of failover.

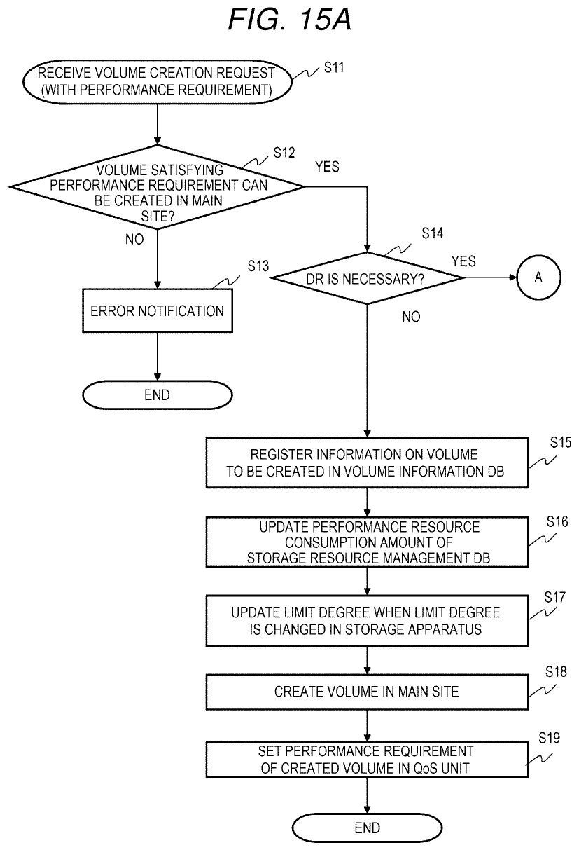

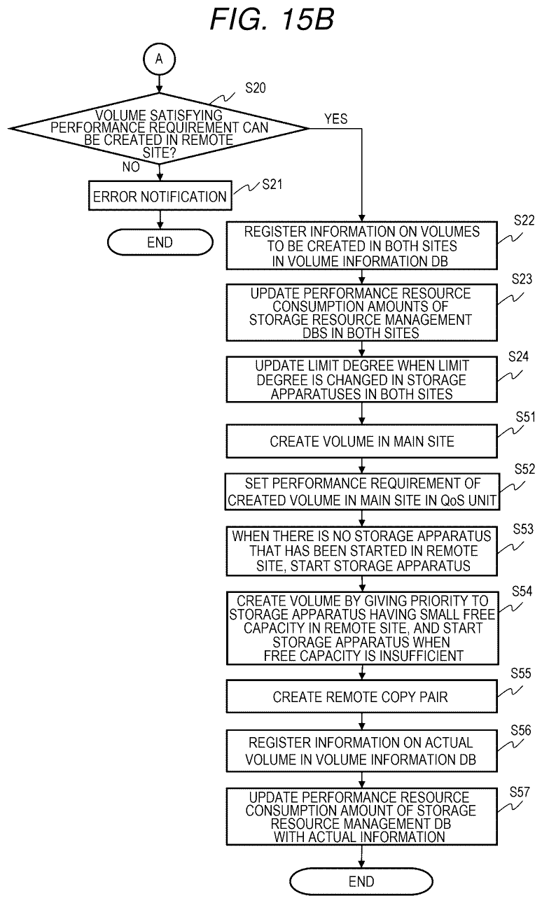

FIGS. 15A and 15B show flowcharts of a processing example of the volume creation unit 202. Steps S11 to S19 shown in FIG. 15A are the same as those described with reference to FIG. 9A. In FIG. 15B, steps S20 to S24 are the same as those described with reference to FIG. 9B.

After step S24, the volume creation unit 202 creates a volume in the main site (S51), and further sets a performance requirement of the volume created in the main site in the QoS unit 112 (S52).

Next, when there is no storage apparatus that has been started in the remote site, the volume creation unit 202 starts any one storage apparatus (S53). When a plurality of storage apparatuses are started in the remote site, the volume creation unit 202 creates a volume by giving priority to a storage apparatus having a small free capacity. When the free capacity is insufficient, a new storage apparatus is started (S54). Accordingly, power consumption and cost can be reduced.

The volume creation unit 202 creates a volume in the remote site and creates a remote copy pair (S54). Next, information on an actual volume is registered in the volume information database 230 (S56), and further a performance resource consumption amount of the storage resource management database 240 is updated with the actual information (S57).

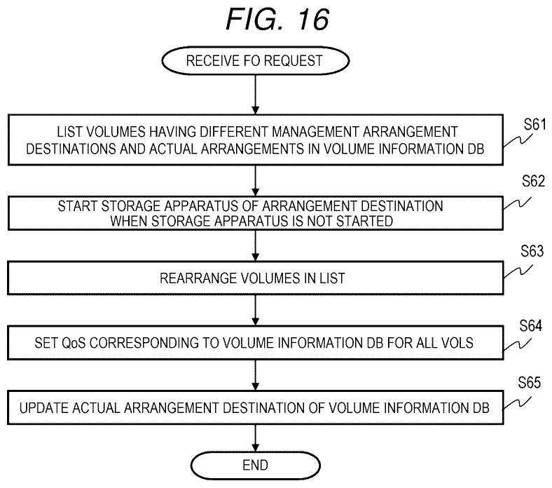

Next, processing of the storage management support unit 203 in failover will be described. FIG. 16 is a flowchart showing a processing example of the storage management support unit 203 in failover. When the storage management support unit 203 receives a request from an application engineer, the storage management support unit 203 creates a list of volumes having different management arrangement destinations and actual arrangements in the volume information database 230 (S61).

The storage management support unit 203 starts a storage apparatus of an arrangement destination when the storage apparatus is not started (S62). The storage management support unit 203 rearranges volumes in the list (S63). The storage management support unit 203 sets QoS of the volume information database 230 for all volumes (S64). The storage management support unit 203 updates an actual arrangement destination of the volume information database 230 (S65).

### Embodiment 3

In the embodiment, it is determined whether a performance requirement of a volume can be satisfied by a rearrangement (rebalance) of volumes without expansion, and an alert indicating expansion or rebalance is output according to a determination result. Accordingly, a burden on an IT administrator can be reduced.

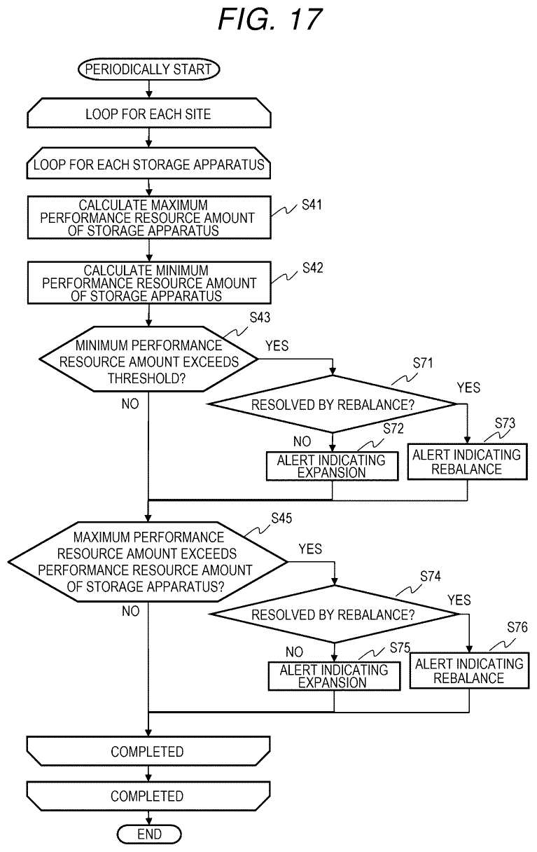

FIG. 17 is a flowchart showing a processing example of the storage management support unit 203. Steps S41, S42, S43, and S45 are the same as those described with reference to FIG. 13. In step S43, when the minimum performance resource amount exceeds the threshold (S43: YES), the storage management support unit 203 determines whether the state is resolved by rebalance (S71). When performance resource shortage is not resolved by rebalance (S71: NO), the storage management support unit 203 outputs an alert indicating expansion (S72), and when the performance resource shortage is resolved by rebalance (S71: YES), the storage management support unit 203 outputs an alert indicating rebalance (S73).

In step S45, when the maximum performance resource amount exceeds a performance resource amount of a storage apparatus (S45: YES), the storage management support unit 203 determines whether the state is resolved by rebalance (S74). When performance resource shortage is not resolved by rebalance (S74: NO), the storage management support unit 203 outputs an alert indicating expansion (S75), and when the performance resource shortage is resolved by rebalance (S74: YES), the storage management support unit 203 outputs an alert indicating rebalance (S76).

Hereinafter, a method for determining resolution of the performance resource shortage by rebalance will be described. The storage management support unit 203 determines whether rebalance is possible in the following procedure based on information on the service catalog database 210, the storage resource management database 240, the volume information database 230, and the site alert threshold management database 250.

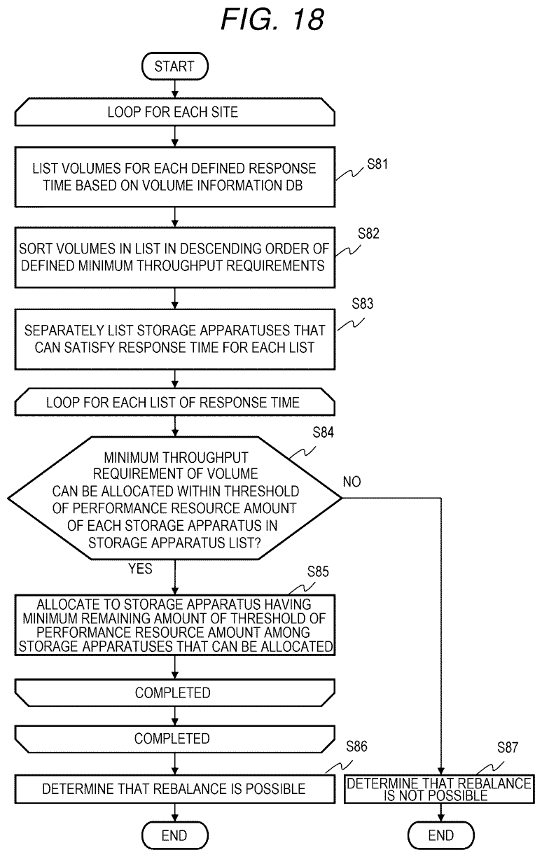

First, rebalance determination S71 when the minimum performance resource amount exceeds the threshold will be described. FIG. 18 is a flowchart showing the rebalance determination when the minimum performance resource amount exceeds the threshold. The storage management support unit 203 executes steps S81 to S85 for each site.

The storage management support unit 203 lists volumes, which are volumes arranged in a site, for each defined response time based on the volume information database 230 (S81). The storage management support unit 203 sorts the volumes in the list in descending order of defined minimum throughput requirements (S82). The storage management support unit 203 separately lists storage apparatuses that can satisfy the response time for each list (S83).

The storage management support unit 203 executes steps S84 and S85 in each list satisfying the response time. The storage management support unit 203 determines whether the minimum throughput requirement of a volume can be allocated within a threshold of a performance resource amount of each storage apparatus in the storage apparatus list (S84).

When the allocation is possible (S84: YES), the storage management support unit 203 selects and allocates a storage apparatus having a minimum remaining amount of the threshold of the performance resource amount among storage apparatuses that can be allocated (S85). Characteristics of each storage apparatus are considered according to Uj/max (αj, βj).

When the allocation is not possible (S84: NO), the storage management support unit 203 ends the processing at that time point and determines that rebalance is not possible. When the processing from steps S81 to S85 is completed to the end, the storage management support unit 203 determines that rebalance is possible (S86).

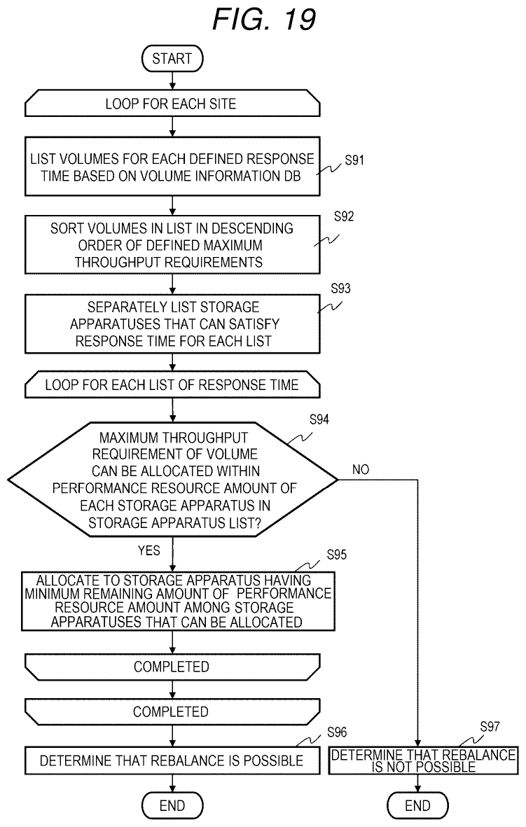

Next, the rebalance determination S74 when the maximum performance resource amount exceeds a performance resource amount of a storage apparatus will be described. FIG. 19 is a flowchart showing the rebalance determination when the maximum performance resource amount exceeds the performance resource amount t of a storage apparatus. The storage management support unit 203 executes steps S91 to S95 for each site.

The storage management support unit 203 lists volumes for each defined response time based on the volume information database 230 (S91). The storage management support unit 203 sorts the volumes in the list in descending order of defined maximum throughput requirements (S92). The storage management support unit 203 separately lists storage apparatuses that can satisfy the response time for each list (S93).

The storage management support unit 203 executes steps S94 and S95 in each list satisfying the response time. The storage management support unit 203 determines whether the maximum throughput requirement of a volume can be allocated within a performance resource amount of each storage apparatus in the storage apparatus list (S94).

When the allocation is possible (S94: YES), the storage management support unit 203 selects and allocates a storage apparatus having a minimum remaining performance resource amount among storage apparatuses that can be allocated (S95). Characteristics of each storage apparatus are considered according to Uj/max (αj, βj).

When the allocation is not possible (S94: NO), the storage management support unit 203 ends the processing at that time point and determines that rebalance is not possible (S97). When the processing from steps S91 to S95 is completed to the end, the storage management support unit 203 determines that rebalance is possible (S96).

Here, an example of determination of resolution of performance resource shortage by rebalance will be described. It is assumed that performance resource shortage occurs in the storage apparatus c100C. First, in the site B100B, in order to list volumes for each response time registered in the volume information database 230, the storage management support unit 203 obtains a response time requirement of a volume arranged in the site B100B.

The storage management support unit 203 acquires the P99 Response Time in the Catalog Name row of the service catalog database 210 based on the Catalog Name column 232 in the volume information database 230, and lists the volumes by “0.1 m/s” and “10 m/s”. Here, “Prod2” and “Prod3” belong to a list of “0.1 m/s”, and “Prod1” and “Prod4” belong to a list of “10 m/s”.

The storage management support unit 203 sorts minimum throughput requirements in descending order in the list of “0.1 m/s”. Here, since “Prod2” is 1280 and “Prod3” is 2560, the storage management support unit 203 sorts “Prod3” and “Prod2” in this order. Similarly, in the list of “10 m/s”, since “Prod1” is 960 and “Prod4” is 560, the storage management support unit 203 sorts “Prod1” and “Prod4” in this order.

Here, in the list of “0.1 m/s”, the storage management support unit 203 confirms, in the sorted order, whether volumes in the list can be allocated in the storage apparatus “c” that can satisfy the response time requirement. First, “Prod3” can be arranged because a performance resource amount of the storage apparatus “c” is 3850. Next, for “Prod2”, a remaining performance resource amount of the storage apparatus “c” is 3850−2560=1290. Thus, “Prod2” can be arranged. Here, the remaining performance resource amount is 1290−1280=10.

Subsequently, in the list of “10 m/s”, the storage management support unit 203 confirms, in the sorted order, whether the volumes in the list can be allocated to the storage apparatuses “c” and “d” that can satisfy the response time.

First, “Prod1” is arranged in the storage apparatus “d” because the remaining performance resource amount of the storage apparatus “c” is 10 and a performance resource amount of the storage apparatus “d” is 1750. Next, “Prod4” is arranged in the storage apparatus “d” because the remaining performance resource amount of the storage apparatus “c” is 10 and a remaining performance resource amount of the storage apparatus “d” is 1750−960=790. Here, a remaining performance resource amount of the storage apparatus “d” is 790−560=230.

Here, since a volume can be rearranged to the end, it is determined that rebalance is effective. Since it has been found an alert is resolved by rearranging “Prod1” arranged in the storage apparatus “c” to the storage apparatus “d” according to the above calculation, the storage management support unit 203 proposes rebalance to an IT administrator using a GUI.

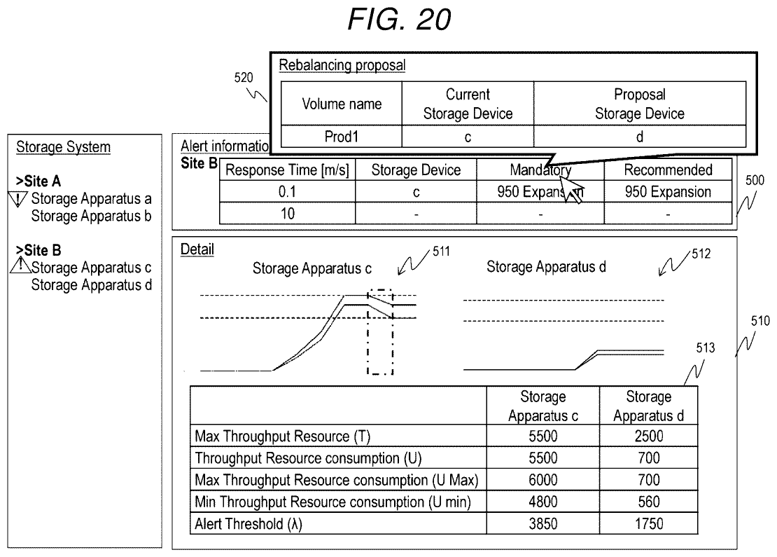

FIG. 20 shows an example of an alert image presented to the terminal 302 of an IT administrator by the storage management support unit 203. The image indicates information on a selected site, and here, the site B is selected. A section 500 indicates the mandatory expansion amount and the recommended expansion amount of a performance resource amount in the site B. 950 is presented as the mandatory expansion amount and the recommended expansion amount for the storage apparatus c100C satisfying a requirement of the response time 0.1.

A section 520 indicates recommended rebalance information. Here, it is proposed to move (rearrange) the volume Prod1 from the current storage apparatus c100C to another storage apparatus d100D.

The section 510 indicates information on performance resource amounts of storage apparatuses in the site B. Specifically, graphs 511 and 512 indicate information on the storage apparatus c100C and the storage apparatus d100D, respectively. The graphs 511 and 512 show a maximum required performance resource amount, a minimum required performance resource amount, an available performance resource amount, and a past value and a calculated value of a time change of a threshold. A rectangle in the graph 511 indicates a period from the start of rearrangement (rebalance) of volumes to the completion of expansion. The table 513 shows information on performance resources of the storage apparatus c100C and the storage apparatus d100D in the site B100B.

The embodiments described above have been described in detail to describe the invention in an easy-to-understand manner, and the invention is not necessarily limited to those including all configurations described above. A part of configurations of an embodiment can be replaced with another configuration. A part of a configuration of an embodiment can also be deleted.

Some or all units, configurations, functions, processing units, and the like described above may be implemented by hardware by, for example, designing with an integrated circuit. The units, configurations, functions, and the like described above may be implemented by software by a processor interpreting and executing a program for implementing the functions. Information such as a program, a table, and a file for implementing each function can be stored in a recording device such as a memory or a hard disk, or a storage medium such as an IC card, an SD card, and a DVD.

Control lines and information lines according to the embodiments described above are considered to be necessary for description, and not all the control lines and the information lines in product are necessarily shown. Actually, almost all configurations may be considered to be connected to one another. The embodiments of the invention have been mainly described above.

What is claimed is:

1. An apparatus for managing a storage system, the apparatus comprising:
a processor; and
a storage device, wherein
the storage device stores storage resource management information for managing information on a throughput performance resource and a response time of a storage apparatus in each of a main site and a remote site, and
the processor is configured to
receive a performance requirement including response performance and throughput performance for a volume copy pair including a primary volume in the main site and a secondary volume in the remote site,
determine whether there is a storage apparatus satisfying the performance requirement in both the main site and the remote site with reference to the storage resource management information, and
determine to create the volume copy pair when there is the storage apparatus satisfying the performance requirement in both the main site and the remote site.

2. The apparatus according to claim 1, wherein
during creation of the volume copy pair, the processor sets an upper limit and a lower limit of throughput performance of each volume of the volume copy pair for the storage apparatus in each of the main site and the remote site.

3. The apparatus according to claim 1, wherein
the storage device stores volume management information for managing a volume arranged in each of the main site and the remote site,
the volume management information manages a management arrangement destination storage apparatus for a volume arranged in the remote site and an actual arrangement destination storage apparatus,
the management arrangement destination storage apparatus satisfies the performance requirement, and
the processor rearranges the secondary volume to the management arrangement destination storage apparatus in failover by the secondary volume and sets an upper limit and a lower limit of throughput performance of the secondary volume in the management arrangement destination storage apparatus.

4. The apparatus according to claim 1, wherein
when a total of required upper limit performance of volumes arranged in a storage apparatus exceeds a performance resource amount of the storage apparatus, the processor reduces upper limit performance of the volumes from the required upper limit performance so that the total of the upper limit performance of the volumes is equal to or less than the performance resource amount.

5. The apparatus according to claim 4, wherein
the processor determines a limit degree of upper limit performance of each of the volumes by using combination optimization.

6. The apparatus according to claim 4, wherein
the processor outputs an alert when the total of the required upper limit performance of the volumes arranged in the storage apparatus exceeds the performance resource amount of the storage apparatus.

7. The apparatus according to claim 4, wherein
the processor outputs an alert indicating rearrangement when the reduction is resolved by rearranging a volume between storage apparatuses in one site.

8. The apparatus according to claim 7, wherein
the processor outputs an alert indicating expansion when the reduction is not resolved by the rearrangement.

9. A method for an apparatus to manage a storage system, wherein
the apparatus stores storage resource management information for managing information on a throughput performance resource and a response time of a storage apparatus in each of a main site and a remote site,
the method comprising:
receiving, by the apparatus, a performance requirement including response performance and throughput performance for a volume copy pair including a primary volume in the main site and a secondary volume in the remote site,
determining, by the apparatus, whether there is a storage apparatus satisfying the performance requirement in both the main site and the remote site with reference to the storage resource management information, and
determining, by the apparatus, to create the volume copy pair when there is the storage apparatus satisfying the performance requirement in both the main site and the remote site.
